(19) United States
(12) Patent Application Publication
(10) Pub. No.: US 2016/0218873 A1
(43) Pub. Date: Jul. 28, 2016

(54) METHOD AND SYSTEM FOR SECURELY STORING AND USING PRIVATE CRYPTOGRAPHIC KEYS

(71) Applicant: Vermont Secure Computing Inc., Woodstock, VT (US)

(72) Inventors: Ian Spiro, Killington, VT (US); Samuel I. Segal, Woodstock, VT (US)

(73) Assignee: Vermont Secure Computing Inc., Woodstock, VT (US)

(21) Appl. No.: 15/004,655

(22) Filed: Jan. 22, 2016

Related U.S. Application Data
(60) Provisional application No. 62/106,392, filed on Jan. 22, 2015.

(51) Int. Cl. H04L 9/08; G06F 21/60

(52) U.S. Cl. CPC H04L 9/0894; G06F 21/602

(57) ABSTRACT

A cryptographic system includes an online computer, an offline computer and custom hardware and software by which the two computers can securely communicate to facilitate the creation, secure use, and maintenance of private cryptographic keys. The system securely stores private cryptographic keys while still enabling the keys to be quickly and easily accessed as needed in a variety of applications including, but not limited to, electronic financial transactions, cryptographic transaction processing, medical record access, email encryption, or any other cryptographic authentication process.

### CROSS REFERENCE TO RELATED APPLICATION

This application claims priority from U.S. Provisional Patent Application No. 62/106,392 filed on Jan. 22, 2015 entitled METHOD AND SYSTEM FOR SECURELY STORING AND USING PRIVATE CRYPTOGRAPHIC KEYS, which is hereby incorporated by reference.

### BACKGROUND

The present application generally relates to computer systems and, more particularly, to methods and systems for creating, securing, using, and maintaining private keys in cryptographic systems.

Cryptographic systems are known to use dedicated offline computers for storing private cryptographic keys. Communication between online and offline computers, which is necessary in order to make use of private keys when interacting with internet facing applications, is often performed over USB drives that are manually connected and disconnected, and perform data transfer by simple read and write operations. This process is far too slow for use by more than a single occasional user. In addition, the use of commercial USB flash drives offers significant attack surfaces to those trying to compromise the offline computer.

### BRIEF SUMMARY OF THE DISCLOSURE

A cryptographic system in accordance with one or more embodiments includes an online (i.e., internet (or other network) connected) computer, an offline (i.e., internet (or other network) disconnected) computer, and custom hardware and software by which the two computers can securely communicate to facilitate the creation, secure use, and maintenance of private cryptographic keys.

This system securely stores private cryptographic keys while still enabling the keys to be quickly and easily accessed as needed in a variety of applications including, but not limited to, electronic financial transactions, cryptographic transaction processing, medical record access, email encryption, or any other cryptographic authentication process.

In accordance with one or more embodiments, the system automates and secures the interaction between online and offline computers. Dedicated, fully authenticated, purpose built communication devices are used to perform these communications without the use of potentially compromised communications standards and hardware.

In accordance with one or more embodiments, a novel combination of hardware and software is used that enforces legitimate, allowable, and valid communication between digital devices through strict enforcement of permitted protocols, data length, response time, and allows only expected data changes throughout the transmission path.

In accordance with one or more embodiments, an electrical to optical signal shift is implemented in order to prevent unobserved remote interrogation of electromagnetic emissions.

In accordance with one or more embodiments, optical communications are performed using a dynamic polarization controller to achieve a desired polarization state that acts as a unique fingerprint on the optical signal.

In accordance with one or more embodiments, the optical communications channel is inherently unable to be non-destructively interrogated (either remotely or through contact), providing de facto detection of MITM (Man In The Middle) attacks.

In accordance with one or more embodiments, electronic communications are marked with hardware specific identifiers and timestamps at each step in the process, implementing a validation factor that the device sending data is the one expected to send data.

In accordance with one or more embodiments, the timing of operations and communications is very tightly constrained, documented, monitored, and validated providing inherent detection of MITM attacks.

In accordance with one or more embodiments, application security is enforced by only permitting a finite and small set of communication operations and verifying the type of operation thoroughly at each step.

In accordance with one or more embodiments, a trivially small electronic transaction whitelist containing all valid operations is used to perform a go/no-go prior to either device parsing the associated request and response data.

In accordance with one or more embodiments, both the online computer and offline computer are housed within nested, physically hardened vaults embedded with a layer of Mu-metal or other electromagnetic shielding material, providing physical, acoustic, optical, and electromagnetic isolation from the outside world and each other.

In accordance with one or more embodiments, the system provides a generic validation failure response to a message deemed invalid at any step in the communication cycle, which flushes buffered data from the communication channel and resets the communication. No specific error messages or information detailing the state of the communication failure or record of the invalid data is stored by either computer, minimizing or reducing the risk of information leakage due to improper error handling techniques.

### BRIEF DESCRIPTION OF THE DRAWINGS

FIGS. 1A-1E (collectively FIG. 1) illustrate an exemplary cryptographic system in accordance with one or more embodiments.

FIG. 2 schematically illustrates the FIG. 1 cryptographic system.

FIG. 3 functionally illustrates communications between the online and offline computers in the cryptographic system in accordance with one or more embodiments.

FIG. 4 functionally illustrates exemplary hardware for communications between the online and offline computers in the cryptographic system in accordance with one or more embodiments.

FIGS. 5A and 5B (collectively FIG. 5) illustrate an exemplary Faraday cage wall design of the cryptographic system in accordance with one or more embodiments.

FIG. 6 is a flow diagram illustrating an exemplary operation of the cryptographic system in accordance with one or more embodiments.

### DETAILED DESCRIPTION

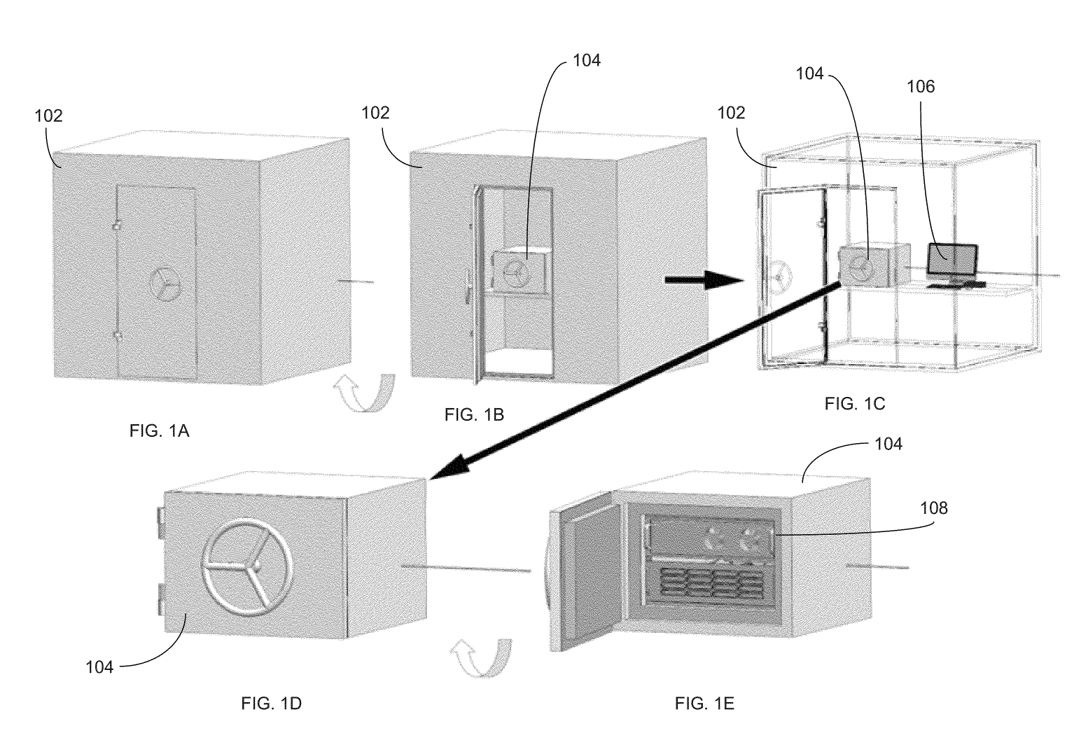

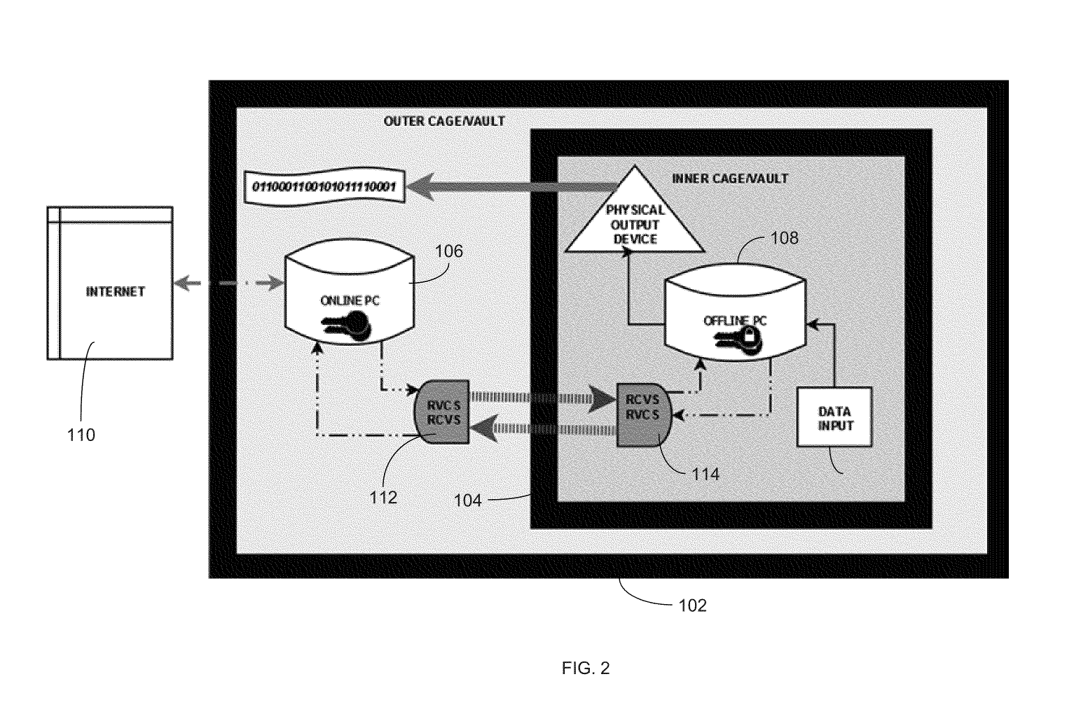

FIGS. 1 and 2 illustrate an exemplary cryptographic system 100 in accordance with one or more embodiments. FIG. 1 illustrates the nested Faraday vaults in the system. FIG. 1A shows the closed outer Faraday vault 102 of the system. FIG. 1B shows the outer vault 102 opened and the inner vault 104 therein. In FIG. 1C, the outer vault 102 is shown wire-framed to reveal an online computer 106 and the inner vault 104. FIG. 1D is an enlarged view of the inner vault 104. FIG. 1E shows the inner vault 104 opened to reveal the offline computer 108.

FIG. 2 schematically illustrates the cryptographic system. The online computer 106, which is located in the outer vault 102, has a connection to outside networks 110 and communicates across dedicated hardware (also referred to herein as the online device and the offline device) 112, 114 with the offline computer 108. The offline computer 108, which is located within the inner vault 104, communicates only across dedicated hardware 112, 114 with the online computer 106.

The online and offline computers 106, 108 can comprise a variety of computer devices including personal computers (e.g., desktop, notebook, and tablet computers). Each computer includes at least one computer processor, a storage medium readable by the processor for storing applications and data, and input/output devices such as, e.g., a keyboard and a display.

The online and offline computers 106, 108 run custom real time operating systems executing tightly time controlled software processes.

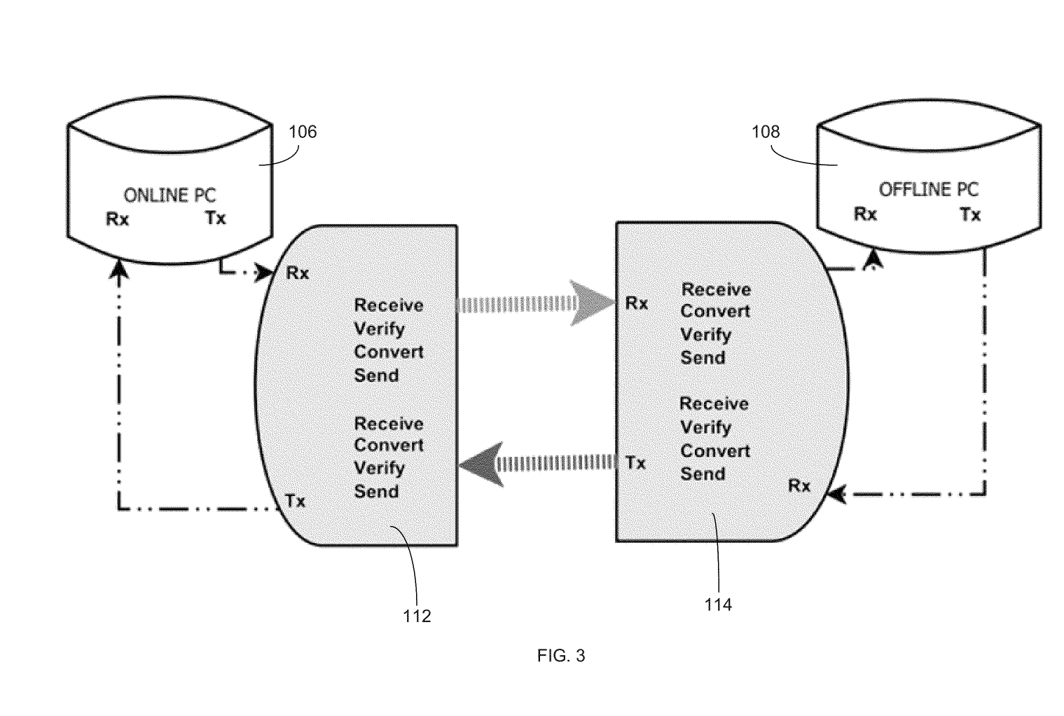

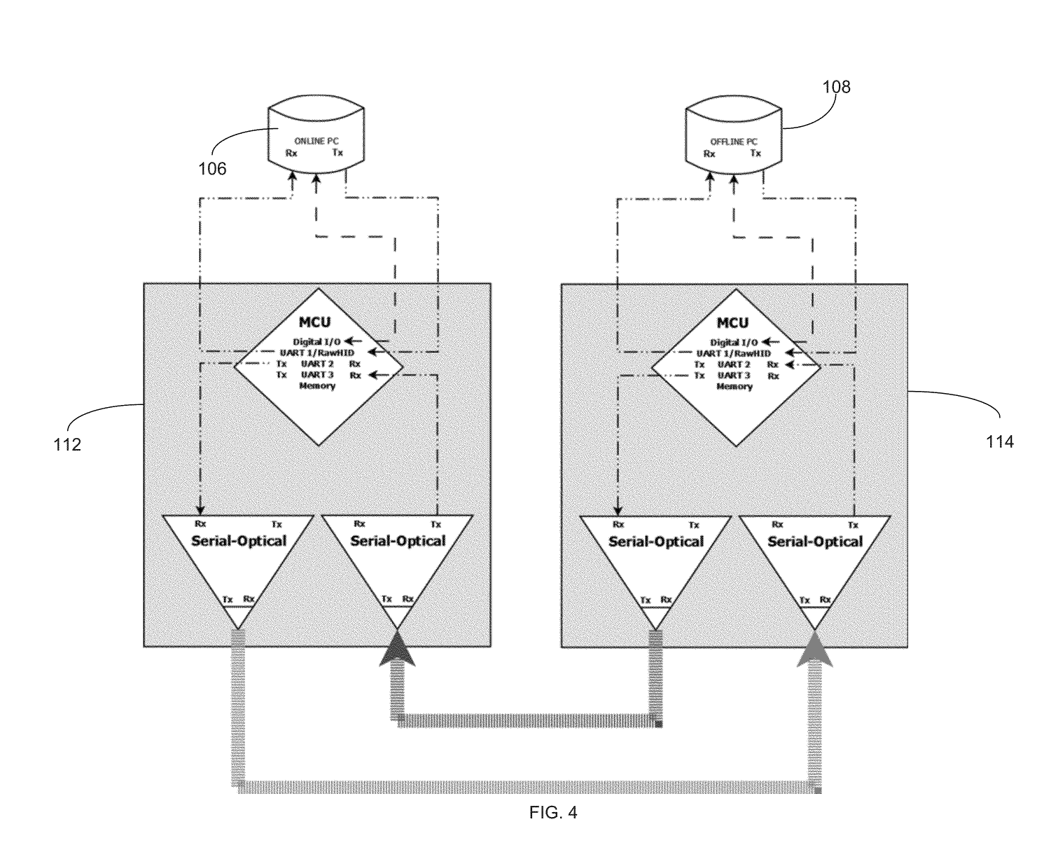

FIG. 3 is a high level schematic diagram illustrating the dedicated hardware 112, 114 across which the online and offline computers 106, 108 communicate with each other. FIG. 4 provides a more detailed functional overview of the dedicated hardware 112, 114. Each of the two shaded rectangles represents a custom piece of hardware 112, 114 containing a high grade embedded system integrated with dual serial-optical converters.

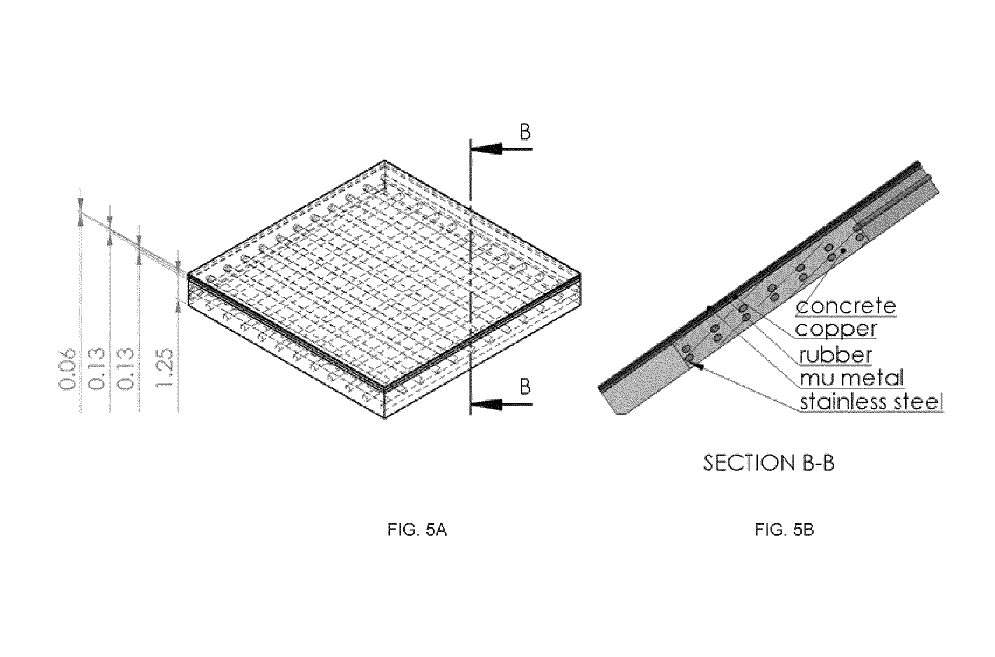

FIG. 5 illustrates details of an exemplary Faraday cage wall design for the inner and outer vaults 102, 104. The cage wall includes a concrete wall robustly reinforced with stainless rebar (to minimize magnetic resonance), lined with rubber isolated layers of copper sheet and Mu-metal to eliminate electromagnetic leakage. The dimensions shown in the figure are by way of example only, and can be varied.

During operation of the cryptographic system, the online computer 106 receives or originates electronic transaction requests or other cryptographic operation requiring private keys. The offline computer 108 generates new public/private key pairs, outputs public keys to the Online computer 106 and stores the corresponding private keys. The offline computer 108 is able to use the private keys it stores to sign electronic transaction requests or other cryptographic operation requests from the Online computer 106.

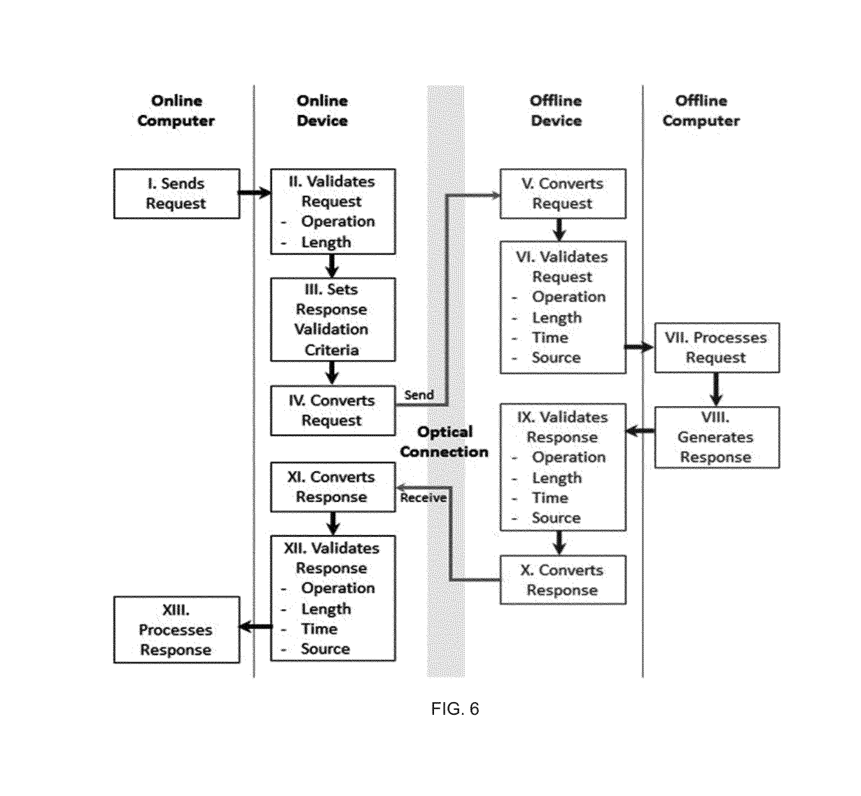

FIG. 6 is a flow diagram illustrating exemplary operation of the cryptographic system.

I. Once the online computer 106 initiates a signing, key creation or other cryptographic operation request, these requests are passed across a combination of dedicated hardware serial and, in parallel, custom communications across generic digital I/O pins to serve as verification of communications into a device 112, which verifies the validity of the incoming request based on length, timing, and a unique identifier.

II. A One Time Machine Authentication Code (OTM) is generated for each request by computation of an XOR operation on the unique device ID expressed in binary together with a one-time randomly generated number, commonly known in the field of application security as a Nonce.

III. Assuming the request communication is verified successfully, the device 112 then appends several unique parameters including the OTM, converts the communications data to light and passes it through the wall of the inner vault 104 to a similar device 114.

IV. The OTM is used to uniquely identify a specific request and will be included in the corresponding response in order to provide a one to one mapping of request to response pairs.

V. This device 114 converts the incoming data stream from light back to electronic serial data and verifies the validity of the incoming request based on length, timing, and a number of parameters unique to a specific combination of online computer 106 and upstream communications device 112.

VI. Assuming the communication is verified successfully, the device 114 then appends a unique identifier, makes note of the electronic transaction and passes the data along to the offline computer 108 via a combination of electronic serial and single ended bit-banged electronic communications.

VII. The offline computer 108 receives the request and performs complementary validation. Assuming the communication is successfully validated, the offline computer 108 performs the requested operation, in a preset amount of time and passes out the result of the operation via a combination of electronic serial and single ended bit-banged electronic communications to its communications device 114.

VIII. This device 114 only accepts incoming data that it is expecting based on issued requests it has white listed. The responses to these requests must arrive in order, properly formatted and on time.

IX. Assuming these conditions are met the device 114 verifies the validity of the request based on length, timing, and a number of parameters unique to a specific combination of offline computer 108 and upstream communications devices all the way back to and including the originating online computer 106.

X. Assuming the communication is verified successfully, the device 114 then appends several unique parameters, makes note of the electronic transaction, converts the communications data to light and passes it through the wall of the inner vault 104 to the device 112 in the outer vault 102. The device 112 only accepts incoming data that it is expecting based on issued requests it has white listed. The responses to these requests must arrive in order, properly formatted and on time.

XI. Assuming these conditions are met the device 112 converts the incoming data stream from light back to electronic serial data and verifies the response data based on expected length, timing, and a number of parameters unique to a specific combination of upstream communications devices including both the offline computer 108 and online computer 106 in the communications chain.

XII. Assuming the communication is verified successfully, the device 112 makes note of the operation and passes the signed electronic transaction or other result of along to the online computer 106 via a combination of dedicated hardware serial and, in parallel, custom communications across generic digital I/O pins to serve as verification of communications.

XIII. The online computer 106 receives the response communication and performs complementary validation. Assuming all validation conditions are upheld throughout the communication cycle, the online computer 106 processes the data contained in the response.

The processes of the cryptographic system described above may be implemented in software, hardware, firmware, or any combination thereof. The processes can be implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions.

Accordingly, the foregoing description and attached drawings are by way of example only, and are not intended to be limiting.

What is claimed is:

1. A computer-implemented method for securely storing and using private cryptographic keys utilizing a cryptographic system comprising an online computer, an offline computer, a first communication device, a second communication device, an inner Faraday cage housing the offline computer and the second communication device, and an outer Faraday cage housing the online computer, the first communication device, and the inner Faraday cage, the method comprising the steps of:
(a) transmitting a cryptographic operation request requiring a private key in an electrical signal from the online computer to the first communication device;
(b) converting, by the first communication device, the electrical signal received from the online computer into an optical signal, and transmitting the optical signal from the first communication device outside the inner Faraday cage to the second communication device inside the inner Faraday cage;
(c) converting, by the second communication device, the optical signal received from the first communication device into an electrical signal, and transmitting the electrical signal to the offline computer;
(d) performing, by the offline computer, the cryptographic operation request, and transmitting a result of the cryptographic operation request to the second communication device in an electrical signal;
(e) converting, by the second communication device, the electrical signal received from the offline computer into an optical signal, and transmitting the optical signal to the first communication device; and
(f) converting, by the first communication device, the optical signal received from the second communication device into an electrical signal, and transmitting the electrical signal to the online computer; and
(g) processing, by the online computer, the electrical signal received from the first communication device.

2. The method of claim 1, wherein the cryptographic operation comprises generating a public/private key pair, outputting the public key to the online computer, and storing the private key, or signing an electronic transaction request.

3. The method of claim 1, further comprising validating each incoming electrical and optical signal by the first communication device and the second communication device.

4. The method of claim 3, wherein validating each incoming electrical and optical signal is performed based on length, timing, and a unique identifier assigned to the request.

5. The method of claim 1, further comprising generating and appending a unique one-time machine authentication code to the request by the first communication device.

6. The method of claim 1, further comprising validating the electrical signal received from the second communication device prior to performing the cryptographic operation request by the offline computer in step (d).

7. The method of claim 1, further comprising determining, by the second communication device, whether the electrical signal received from the offline computer in step (e) is white listed, has arrived in order, is properly formatted, and is on time, before converting the electrical signal to an optical signal.

8. The method of claim 1, further comprising validating the electrical signal received from the first communication device prior to processing the electrical signal received from the second communication device by the online computer in step (e).

9. The method of claim 1, wherein the inner Faraday cage and the outer Faraday cage each include concrete walls reinforced with stainless steel rebar to reduce magnetic resonance and lined with isolated layers of copper sheet and Mu-metal to inhibit electromagnetic leakage.

10. A cryptographic system for securely storing and using private cryptographic keys, comprising:
an online computer for receiving or originating a cryptographic operation request requiring a private key;
a first communication device connected to the online computer for transmission of electrical signals therebetween;
a second communication device connected to the first communication device for transmission of optical signals therebetween;
an offline computer for performing the cryptographic operation to generate a result, said offline computer connected to the second communication device for transmission of electrical signals therebetween;
an inner Faraday cage housing the offline computer and the second communication device; and
an outer Faraday cage housing the online computer, the first communication device, and the inner Faraday cage in a nested arrangement;
wherein the online computer transmits the cryptographic operation request to the offline computer and the offline computer transmits the result of the cryptographic operation to the online computer only across the first communication device and the second communication device.

11. The cryptographic system of claim 10, wherein the first communication device and the second communication device each include serial-optical converters for converting electrical signals to optical signals and optical signals to electrical signals.

12. The cryptographic system of claim 10, wherein the cryptographic operation comprises generating a public/private key pair, outputting the public key to the online computer, and storing the private key, or signing an electronic transaction request.

13. The cryptographic system of claim 10, wherein the first communication device and the second communication device are configured to validate each electrical signal and optical signal received by said device.

14. The cryptographic system of claim 13, wherein the online computer, the first communication device, the second communication device, and the offline computer are configured to validate each incoming electrical or optical signal.

15. The cryptographic system of claim 10, wherein the first communication device is configured to generate and append a unique one-time machine authentication code to the request received from the online computer.

16. The cryptographic system of claim 10, wherein the second communication device is configured to determine whether an electrical signal received from the offline computer is white listed, has arrived in order, is properly formatted, and is on time, before converting the electrical signal to an optical signal.

17. The cryptographic system of claim 10, wherein the inner Faraday cage and the outer Faraday cage each include concrete walls reinforced with stainless steel rebar to reduce magnetic resonance and lined with isolated layers of copper sheet and Mu-metal to inhibit electromagnetic leakage.
